(19) United States
(12) Patent Application Publication
(10) Pub. No.: US 2011/0035906 A1
(43) Pub. Date: Feb. 17, 2011

(54) VEHICLE DOOR HINGE DEVICE

(75) Inventors: Fumihisa Esaki, Aichi (JP); Masaru Shashiki, Aichi (JP)

Correspondence Address: OSHA LIANG L.L.P., TWO HOUSTON CENTER, 909 FANNIN, SUITE 3500, HOUSTON, TX, 77010, US

(73) Assignee: TIMS CO., LTD., Toyota-City, Aichi (JP)

(21) Appl. No.: 12/988,920

(22) PCT Filed: Nov. 12, 2009
(86) PCT No.: PCT/JP2009/069255

§ 371 Date: Oct. 21, 2010

(30) Foreign Application Priority Data
Dec. 5, 2008 (JP) 2008-310655

(51) Int. Cl. E05D 11/06; E05D 3/02; E05D 5/06

(52) U.S. Cl. 16/374; 16/386

(57) ABSTRACT

A vehicle door hinge device is formed of a vehicle side bracket attached to the vehicle body, a door side bracket attached to the door, and a hinge pin for turnably connecting both brackets. Each of the brackets is formed of a member with the U-like cross section by subjecting a metal board as a base material to a predetermined bending process. The device is provided with a stopper portion for regulating the relative turning motion between the brackets, wherein the stopper portion is provided on a longitudinal wall portion of the vehicle side bracket.

### CROSS-REFERENCE TO RELATED APPLICATIONS

The present application is a National Stage Application of PCT Application No. PCT/JP2009/069255 filed on Nov. 12, 2009, which claims priority rights based on the Japanese Patent Application 2008-310655, filed in Japan on Dec. 5, 2008. The total disclosure of the Patent Application of the senior filing date is to be incorporated herein by reference.

### BACKGROUND OF INVENTION

1. Field of the Invention

The present invention relates to a hinge device used for a vehicle door and the like, and more particularly, to a vehicle door hinge device provided with a stopper mechanism for retaining an open state of the door.

2. Background Art

As Japanese Unexamined Patent Application Publication No. 2006-161294 discloses, the generally employed door hinge device for vehicle includes a vehicle side bracket attached to a pillar of the vehicle, and a door side bracket attached to the vehicle door. Those brackets are turnably linked via a hinge pin. The aforementioned structure is further provided with a stopper mechanism for retaining a relative open angle defined by those brackets, that is, the door open angle at a predetermined value.

[Patent Document 1] Japanese Unexamined Patent Application Publication No. 2006-161294

### SUMMARY OF THE INVENTION

The vehicle side bracket attached to the vehicle body, that is, the vehicle side hinge member of the aforementioned generally employed type is formed by subjecting a channel-shaped member to a draw molding process into an L-like shape. In other words, it is formed by subjecting a predetermined board as a base material to the draw molding, thus necessitating the complicated process steps. The present invention provides the vehicle door hinge device formed of inexpensive hinge member through a simplified process for bending the sheet metal material as the base member to solve the aforementioned problem.

A vehicle door hinge device as a first aspect of the present invention includes a vehicle side bracket attached to a vehicle body, a door side bracket which is attached to a door and formed to allow a relative turning motion with respect to the vehicle side bracket, and a hinge pin for connecting the brackets to be turnable. Each of the brackets is formed of a member with a U-like cross section derived from subjecting a metal board as a base material to a predetermined bending process. A rib portion which protrudes obliquely inward is integrally provided on a raising portion of a longitudinal wall portion.

Basically, a second aspect of the present invention is based on the concept substantially the same as that of the first aspect as described above. That is, in the structure, a stopper portion which protrudes inward for regulating the turning motion of the door side bracket is integrally formed on the longitudinal wall portion of the vehicle side bracket with the U-like cross section.

Basically, a third aspect of the present invention is based on the concept substantially the same as that of the first aspect as described above. That is, in the structure, the rib portion is provided on the longitudinal wall portion of the vehicle side bracket with the U-like cross section from a raising portion to a position below the portion around which the hinge pin is provided. A stopper portion for regulating the turning motion of the door side bracket is formed at an uppermost end of the rib portion.

In the first aspect of the present invention, the sheet metal product is used for forming both the vehicle side bracket and the door side bracket through the process for bending the metal plate material. This makes it possible to obtain those brackets through the simple molding process. Conventionally, the draw molding process has been employed for forming the bracket, which requires the metal mold with complicated structure. This may increase the manufacturing cost. Meanwhile, the present invention eliminates the need of preparing the metal mold for the draw molding process, thus reducing the manufacturing cost.

Basically, the second aspect of the present invention provides substantially the same effect as the one derived from the first aspect of the invention. In the present invention, the stopper portion is formed on a longitudinal wall of the vehicle side bracket with the U-like cross section such that the relative turning motion between the vehicle side bracket and the door side bracket is regulated at the stopper portion as the base point. The turning motion of both brackets, that is, the opening/closing operation of the vehicle door may be regulated at the point as described above.

Basically, the third aspect of the present invention also provides substantially the same effect as the one derived from the first aspect of the invention. In the present invention, the rib portion which protrudes inward is further formed on the longitudinal wall of the bracket with the U-like cross section at a position around which the hinge pin is provided. This makes it possible to improve rigidity of the vehicle side bracket. The stopper portion may be formed as the top end of the rib portion, which serves to regulate the relative turning motion between both brackets. As a result, the angle at which the door is opened/closed is limited, thus restricting further opening of the door. The aforementioned device for regulating the door open angle may be formed of the simple mechanism. This makes it possible to reduce the mass of the vehicle door hinge device as a whole.

### BRIEF DESCRIPTION OF THE DRAWINGS

FIG. 1 is a perspective view illustrating an entire structure of the present invention.

FIG. 2 is an exploded view of parts illustrating the entire structure of the present invention.

FIG. 3 is a view illustrating a basic operation of the structure according to the present invention.

FIG. 4 is a view illustrating an operation of the structure as another embodiment of the present invention.

FIG. 5 is an explanatory view of an assembly of the structure according to the present invention.

### DETAILED DESCRIPTION

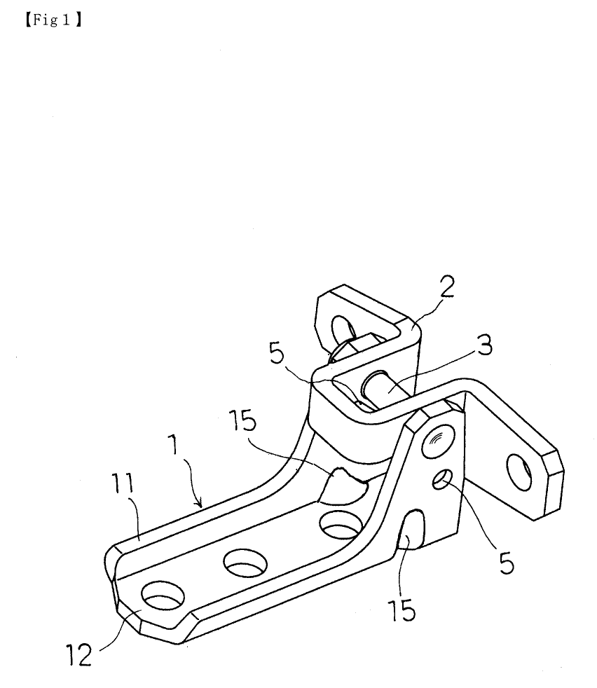

One or more embodiments of the invention will be described referring to FIGS. 1 to 5. Referring to FIG. 1, the device according to the embodiment includes a vehicle side bracket 1 attached to the vehicle body, a door side bracket 2 attached to the door so as to be allowed to turn relative to the vehicle side bracket 1, and a hinge pin 3 for turnably linking those brackets. In the thus structured device, each of the brackets 1 and 2 is formed of the member with the U-like cross section obtained by subjecting the metal plate material as the base material to the predetermined bending process. The above-structured device is further provided with a stopper portion 5 for regulating the relative turning motion between the brackets 1 and 2 on a longitudinal wall portion 11 of one of the brackets, that is, the vehicle side bracket 1 as the female side in the embodiment, which locates below the position where the hinge pin 3 is provided as the point for connection to the door side bracket 2.

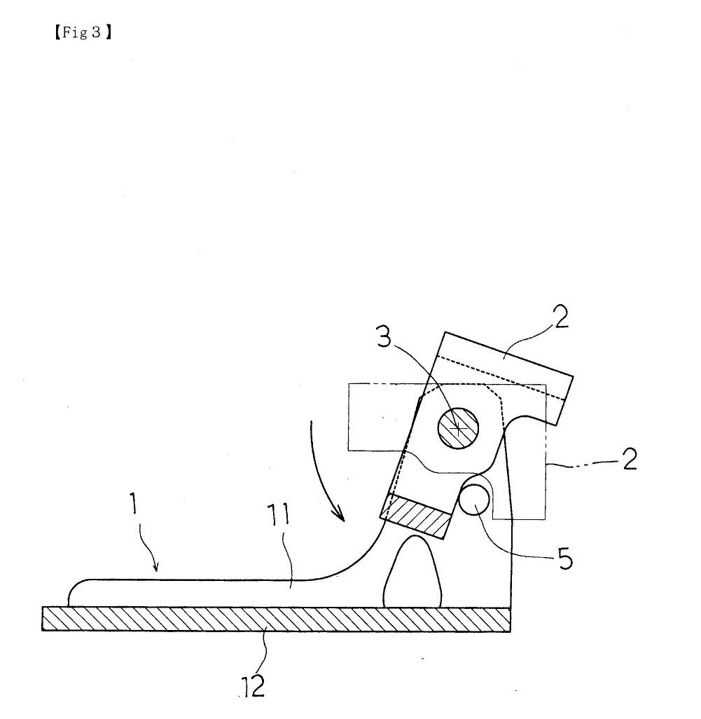

The stopper portion 5 formed as a protrusion which protrudes inward from the upper surface of the longitudinal wall 11 as shown in FIG. 1 or 3, and integrally formed on the longitudinal wall portion 11. Specifically, the stopper portion 5 as the protrusion which protrudes inward is formed by subjecting the longitudinal wall portion 11 of the vehicle side bracket 1 as the female portion to the punching molding process. A rib portion 15 is formed at the raising portion of the longitudinal wall portion 11 with the aforementioned stopper portion 5 as a portion connected to a bottom surface 12 for forming the U-like channel portion as shown in FIG. 1. Only the single rib portion 15 may be used, or plural rib portions 15 may be provided along the longitudinal direction of the bottom surface 12. The use of the rib portion 15 is intended to improve rigidity of the vehicle side bracket 1 as a whole, which is formed through the process for bending the metal plate material.

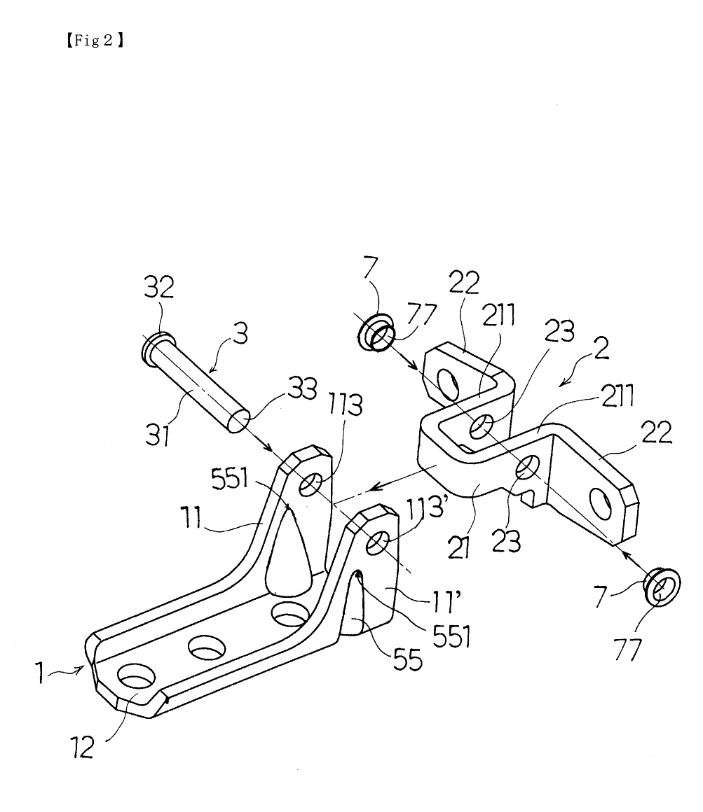

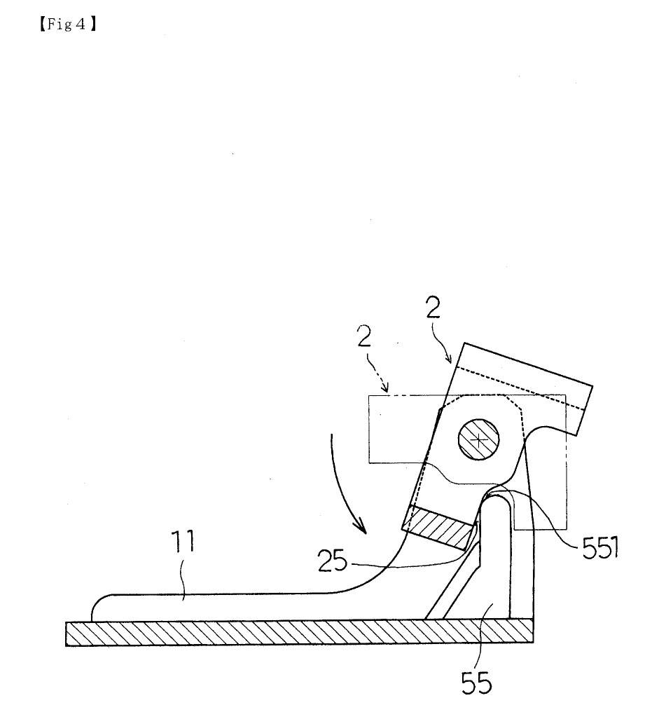

A drive bead member 55 which is sequentially formed upward from the raising portion of the longitudinal wall portion 11 may function as the stopper portion 5 formed on the aforementioned longitudinal wall portion 11 as shown in FIG. 2 or 4. A top end portion 551 of the aforementioned structure abuts on a lower end portion 25 of the door side bracket 2 to restrict further turning motion of the door side bracket 2 to finally stop the turning motion of the door as shown in FIG. 4, for example.

The door side bracket 2 attached to the above-structured door side bracket 1 via the hinge pine 3 while being allowed to have the relative turning motion therewith will be described. Basically, it may be obtained through the process for bending the single sheet of the metal plate material into the U-like shape. Specifically, the door side bracket 2 is formed by bending the belt-like member into the U-like shape as shown in FIG. 2, and includes a main body portion 21 formed to be fit with the space between longitudinal wall portions 11, 11′ of the vehicle side bracket 1, and door side attachments 22, 22 formed by bending both sides of the U-like longitudinal wall portions 211, 211 for forming the main body portion 21 each at substantially a right angle with respect to the U-like longitudinal wall portions 211, 211. Bush insertion holes 23, 23 are formed in the U-like longitudinal wall portions 211, 211, which allow insertion of plastic bushes 7, 7, respectively.

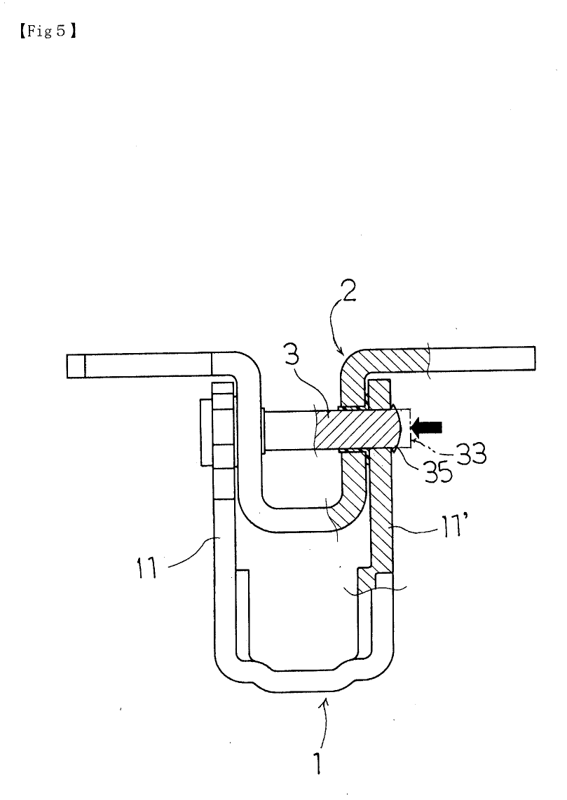

The procedure for attaching the door side bracket 2 having the bushes 7, 7 inserted in the U-like longitudinal wall portions 211, 211 to the vehicle side bracket 1 will be described referring to FIG. 2. The door side bracket 2 in the aforementioned state is inserted into the space between the longitudinal wall portions 11, 11′ of the vehicle side bracket 1. Inner bores 77, 77 of the bushes 7, 7 fit with the U-like longitudinal wall portions 211, 211 of the door side bracket 2 are aligned with hinge pin insertion holes 113, 113′ formed in the longitudinal wall portions 11, 11′ of the vehicle side bracket 1. In the aforementioned state, the hinge pin 3 is inserted from the hinge pin insertion hole 113 formed in one of the longitudinal wall portions 11, and is pushed until its leading end 33 appears outside the hinge pin insertion hole 113′ formed in the other longitudinal wall portion 11′. In this state, the leading end 33 of the hinge pin 3 is processed through coking means as shown in FIG. 5 to form another flange portion 35 for preventing the hinge pin 3 from falling. This makes it possible to connect the vehicle side bracket 1 with the door side bracket 2 via the hinge pin 3 while being allowed to have the relative turning motion.

The above structured device of the embodiment provides the following advantages. That is, the vehicle side bracket 1 and the door side bracket 2 are formed of the metal sheet products subjected to bending of the metal plate material. This makes it possible to provide the brackets 1 and 2 through the simple molding process. Conventionally, the draw molding process for forming the brackets requires the mold with the complicated structure, resulting in the increased manufacturing cost. Meanwhile, the device according to the present invention eliminates the need of the mold for the drawing process, thus reducing the manufacturing cost.

In the device according to the embodiment, the stopper portion 5 is disposed on the longitudinal wall portions 11 and 11′ of the vehicle side bracket 1 with the U-like cross section. The relative turning motion between the vehicle side bracket 1 and the door side bracket 2 is regulated at the stopper portion 5 to ensure regulation of the turning motion, that is, the opening/closing operations of the vehicle side door. In the embodiment, the drive bead portion 55 formed to protrude inward and to serve as the rib portion is provided around the portion where the hinge pin 3 is formed on the longitudinal wall portions 11 and 11′ of the bracket with the U-like cross section as shown in FIG. 2, for example. This makes it possible to improve rigidity of the vehicle side bracket 1 as a whole. The top ends 551 of the drive bead portions 55 form the stopper portion such that the relative turning motion between the brackets 1 and 2 is regulated around the top ends 551 of the drive bead portions 55. As a result, the opening/closing angle of the door may be limited to regulate further opening of the door. As the device for regulating the door opening angle may be formed as the simple mechanism, the mass of the vehicle door hinge device may be reduced as a whole.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

### EXPLANATION OF SYMBOLS

1: vehicle side bracket

11: longitudinal wall portion

11′: longitudinal wall portion

113: hinge pin insertion hole

113′: hinge pin insertion hole

12: bottom surface

15: rib portion

2: door side bracket

21: main body portion

211: longitudinal wall portion

22: door side attachment

23: bush insertion hole

25: lower end portion

3: hinge pin

33: leading end

35: flange portion

5: stopper portion

55: drive bead portion

7: bush

77: inner bore

1. A vehicle door hinge device comprising:
a vehicle side bracket attached to a vehicle body;
a door side bracket attached to a door and formed to allow a relative turning motion with respect to the vehicle side bracket; and
a hinge pin for turnably connecting the brackets, wherein
each of the brackets is formed of a member with a U-like cross section derived from subjecting a metal board as a base material to a predetermined bending process; and
a rib portion which protrudes obliquely inward is integrally provided on a raising portion of a longitudinal wall portion of the vehicle side bracket.

2. The vehicle door hinge device according to claim 1, wherein
a stopper portion which protrudes inward for regulating the turning motion of the door side bracket is integrally formed on the longitudinal wall portion of the vehicle side bracket with the U-like cross section.

3. The vehicle door hinge device according to claim 1, wherein
the rib portion is provided on the longitudinal wall portion of the vehicle side bracket with the U-like cross section from a raising portion to a position below the portion around which the hinge pin is provided; and
a stopper portion for regulating the turning motion of the door side bracket is formed at an uppermost end of the rib portion of the vehicle side bracket.
